(19) United States
(12) Patent Application Publication
(10) Pub. No.: US 2018/0157072 A1
(43) Pub. Date: Jun. 7, 2018

(54) LIQUID CRYSTAL CELL AND THREE-DIMENSIONAL STRUCTURAL LIQUID CRYSTAL CELL

(71) Applicant: FUJIFILM Corporation, Tokyo (JP)

(72) Inventor: Junichi HIRAKATA, Minami-ashigara-shi (JP)

(73) Assignee: FUJIFILM Corporation, Tokyo (JP)

(21) Appl. No.: 15/883,522

(22) Filed: Jan. 30, 2018

Related U.S. Application Data
(63) Continuation of application No. PCT/JP2016/072408, filed on Jul. 29, 2016.

(30) Foreign Application Priority Data
Jul. 31, 2015 (JP) 2015-152909

(51) Int. Cl. G02F 1/1339; G02F 1/1333

(52) U.S. Cl. CPC G02F 1/1339; G02F 2202/28; G02F 2001/13398; G02F 1/133305

(57) ABSTRACT

An object of the invention is to provide a liquid crystal cell having a sealing material which does not lose sealability even in a case where a plastic substrate is largely deformed as it is stretched or contracted, and a three-dimensional structural liquid crystal cell using the liquid crystal cell. A liquid crystal cell according to the invention includes at least two plastic substrates, a liquid crystal layer, and a sealing material which has an elongation rate of 5% to 200% between two neighboring ones of the plastic substrates, and the liquid crystal layer is sealed with the sealing material.

### CROSS-REFERENCE TO RELATED APPLICATIONS

This application is a Continuation of PCT International Application No. PCT/JP2016/072408 filed on Jul. 29, 2016, which claims priority under 35 U.S.C. § 119(a) to Japanese Patent Application No. 2015-152909 filed on Jul. 31, 2015. The above application is hereby expressly incorporated by reference, in its entirety, into the present application.

### BACKGROUND OF THE INVENTION

### 1. Field of the Invention

The present invention relates to a liquid crystal cell using a plastic substrate and a three-dimensional structural liquid crystal cell using the liquid crystal cell.

### 2. Description of the Related Art

In recent years, liquid crystal display devices have been developed into various forms, and flexible displays which are lightweight and can be bent have attracted attention.

In a liquid crystal cell which is used in such a flexible display, a glass substrate which has been used is difficult to meet the demand for weight reduction and bending. Accordingly, various plastic substrates have been examined as a replacement for the glass substrate.

The liquid crystal cell is also used in a dimming device which is used for interior decoration, a building material, a vehicle, or the like. These dimming devices are also desired to be reduced in weight and to have flexibility for bending, and regarding a substrate for these uses, a plastic substrate is required to be put into practical use as a replacement for the glass substrate.

In a case where flexibility is imparted to the liquid crystal cell, it is necessary for a sealing material for sealing a liquid crystal compound in the liquid crystal cell to also have flexibility.

As a sealing material having flexibility, for example, JP1987-18523A (JP-S62-18523A) discloses a sealing material using an epoxy resin-cured product having flexibility imparted thereto.

### SUMMARY OF THE INVENTION

The level of flexibility required for a liquid crystal cell has been increased, and it is required to maintain adhesiveness against stretching or contraction occurring during three-dimensional forming, as well as strong resistance to bending.

Accordingly, an object of the invention is to provide a liquid crystal cell having a sealing material which does not lose sealability even in a case where a plastic substrate is largely deformed as it is stretched or contracted, and a three-dimensional structural liquid crystal cell using the liquid crystal cell.

The inventors have conducted intensive studies, and found that by adjusting an elongation rate of a sealing material used in a liquid crystal cell to a specific value, it is possible to maintain functions of the liquid crystal cell without losing sealability even in a case where a plastic substrate is largely deformed.

That is, the inventors have found that the object can be achieved with the following configuration.

[1] A liquid crystal cell comprising at least two plastic substrates; a liquid crystal layer; and a sealing material which has an elongation rate of 5% to 200% between two neighboring ones of the plastic substrates, in which the liquid crystal layer is sealed with the sealing material.

[2] The liquid crystal cell according to [1], in which the sealing material is a photosensitive resin layer.

[3] The liquid crystal cell according to [1] or [2], in which at least one of the plastic substrates is a heat-shrinkable film satisfying a heat shrinkage rate of 5% to 75%.

[4] The liquid crystal cell according to [3], in which all the plastic substrates are heat-shrinkable films satisfying a heat shrinkage rate of 5% to 75%.

[5] The liquid crystal cell according to any one of [1] to [4], in which at least one of the plastic substrates is a thermoplastic resin film stretched at a ratio of greater than 0% and not greater than 300%.

[6] A three-dimensional structural liquid crystal cell which is formed by changing dimensions of the liquid crystal cell according to any one of [1] to [5] by ±5% to 75%.

According to the invention, it is possible to provide a liquid crystal cell having a sealing material which does not lose sealability even in a case where a plastic substrate is largely deformed as it is stretched or contracted, and a three-dimensional structural liquid crystal cell using the liquid crystal cell.

### BRIEF DESCRIPTION OF THE DRAWINGS

FIG. 1 is a schematic perspective view illustrating an aspect of a plastic substrate and a photosensitive resin layer used in the invention.

FIG. 2A is a schematic view of an exposure mask used in an example.

FIG. 2B is a schematic view of another exposure mask used in an example.

FIG. 3A is a schematic view illustrating a method of producing the three-dimensional structural liquid crystal cell produced in the example, and illustrating a state before heating and forming.

FIG. 3B is a schematic view illustrating a method of producing the three-dimensional structural liquid crystal cell produced in the example, and illustrating a state after heating and forming.

### DESCRIPTION OF THE PREFERRED EMBODIMENTS

Hereinafter, the invention will be described in detail.

The following description of constituent requirements is based on typical embodiments of the invention, but the invention is not limited thereto.

In this specification, a numerical value range expressed using “to” means a range including numerical values before and after “to” as a lower limit value and an upper limit value.

In this specification, parallel or perpendicular does not mean parallel or perpendicular in a strict sense, but means a range of having ±5° from parallel or perpendicular.

### Liquid Crystal Cell

A liquid crystal cell according to the invention has at least two plastic substrates and a liquid crystal layer. The liquid crystal cell further has a sealing material having an elongation rate of 5% to 200% between neighboring two of the plastic substrates, and the liquid crystal layer is sealed by the sealing material.

In the invention, a liquid crystal cell includes a liquid crystal cell which is used in a liquid crystal display device for use in a thin television, a monitor, a laptop computer, a cell phone, or the like, and a liquid crystal cell which is used in a dimming device which changes the intensity of light to be applied for interior decoration, a building material, a vehicle, or the like.

That is, a liquid crystal cell is a generic term for devices which drive a liquid crystal material or the like enclosed between two substrates.

In this specification, the terms liquid crystal cell before three-dimensional forming and three-dimensional structural liquid crystal cell after three-dimensional forming of the liquid crystal cell may be separately used.

Regarding drive modes of the liquid crystal cell, various methods can be used including a horizontal alignment mode (In-Plane-Switching: IPS), a vertical alignment mode (Vertical Alignment: VA), a twisted nematic mode (Twisted Nematic: TN), and a super twisted nematic mode (Super Twisted Nematic: STN).

In the liquid crystal cell according to the invention, a conductive film for driving a liquid crystal by applying a voltage, an alignment film for putting liquid crystal molecules into a desired alignment state, dye molecules used to change the intensity of light in a dimming element, and the like may be used in combination.

A backlight member, a polarizer member, or the like may be additionally provided or bonded to the outside of the liquid crystal cell in accordance with the configuration of the liquid crystal cell.

### Sealing Material

The sealing material used in the invention has an elongation rate of 5% to 200%.

Using the sealing material, it is possible to maintain functions of the liquid crystal cell as a three-dimensional structural liquid crystal cell without losing sealability even in a case where dimensions of the liquid crystal cell are largely changed.

In the invention, the elongation rate of the sealing material is preferably 50% to 200%, and more preferably 100% to 200%.

In the invention, a photosensitive resin layer is preferably used as the sealing material. It is preferable that a photosensitive resin layer is used as the sealing material since functions of the liquid crystal cell as a three-dimensional structural liquid crystal cell are easily maintained without losing sealability even in a case where dimensions of the liquid crystal cell are largely changed.

### Elongation Rate

In the invention, the elongation rate of the sealing material is an elongation rate of a cured sealing material, and is an elongation rate (%) obtained from a length between marked lines at the time when the sealing material pulled at a tensile speed of 10 mm/min is cut using a Tensilon tensile test based on a plastic tensile test method (JIS K 6301).

### Photosensitive Resin Layer

The photosensitive resin layer suitably used as the sealing material is a resin layer (cured layer) which is disposed on the plastic substrate and has a pattern formed through an exposure step and a development step.

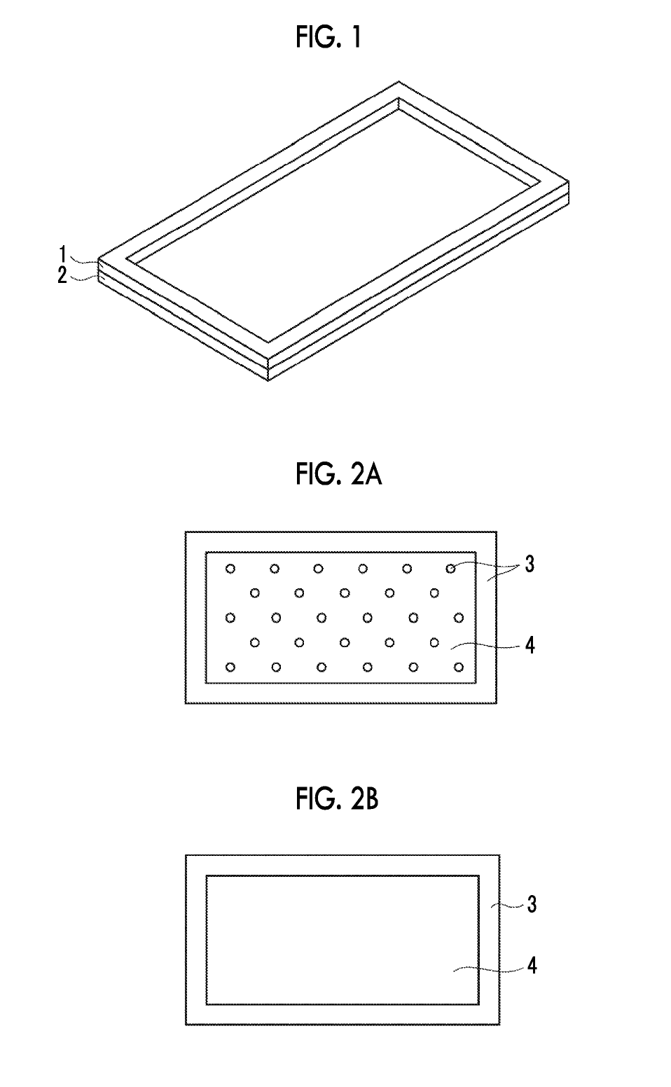

As illustrated in FIG. 1, it is preferable that a photosensitive resin layer 1 is formed on a plastic substrate 2 and surrounds an outer periphery of the plastic substrate 2 to seal a liquid crystal layer in a case where the liquid crystal layer is interposed between two plastic substrates.

In addition, a spacer for adjusting a cell gap of the liquid crystal cell can also be formed simultaneously.

Hereinafter, the photosensitive resin layer used in the invention will be described.

The photosensitive resin layer used in the invention can be formed using a photosensitive composition or a photosensitive resin transfer film on the plastic substrate.

The photosensitive resin layer used in the invention may be a negative material or a positive material. A negative material is preferable from the viewpoint of ease-of-production.

Suitable examples of the method of forming the photosensitive resin layer on the plastic substrate suitably include (a) a method of performing coating with a solution containing a photosensitive composition through a known coating method and (b) a lamination method using a transfer method using a photosensitive resin transfer film. Hereinafter, these methods will be described in detail.

### (a) Coating Method

The photosensitive composition can be applied by a known coating method such as a spin coating method, a curtain coating method, a slit coating method, a dip coating method, an air knife coating method, a roller coating method, a wire bar coating method, a gravure coating method, or an extrusion coating method using a hopper described in U.S. Pat. No. 2,681,294A. Among these, a method using a slit nozzle or a slit coater described in JP2004-89851A, JP2004-17043A, JP2003-170098A, JP2003-164787A, JP2003-10767A, JP2002-79163A, JP2001-310147A, or the like is suitable.

### (b) Transfer Method

In a case where transfer is performed, a photosensitive resin layer formed into a film on a temporary support using a photosensitive resin transfer film is bonded to a support surface by pressure bonding or thermal pressure bonding with a heated and/or pressurized roller or flat plate, and then the photosensitive resin composition layer is transferred onto a support by peeling the temporary support. Specifically, a laminator or a lamination method described in JP1995-110575A (JP-H07-110575A), JP1999-77942A (JP-H11-77942A), JP2000-334836A, or JP2002-148794A is used, and a method described in JP1995-110575A (JP-H07-110575A) is preferably used from the viewpoint of a low content of foreign substances.

In a case where the photosensitive resin layer is formed, an oxygen blocking layer can be further provided between the photosensitive resin layer and the temporary support. Accordingly, exposure sensitivity can be increased. In addition, a thermoplastic resin layer having a cushioning property is also preferably provided in order to improve transferability.

The method of producing the temporary support, the oxygen blocking layer, the thermoplastic resin layer, or other layers constituting the photosensitive transfer film, or the photosensitive transfer film is similar to the configuration and producing method described in paragraphs [0024] to [0030] in JP2006-23696A.

In a case where the photosensitive resin layer is formed by coating in both of the (a) coating method and the (b) transfer method, the thickness thereof is preferably 1 to 20 μm, and more preferably 2 to 15 μm. When the thickness is within the above range, pin holes are prevented from being generated during the formation by coating in the manufacturing, and thus it is possible to remove an unexposed part by development without requiring a long period of time.

### Photosensitive Composition

Next, the photosensitive composition will be described.

As the photosensitive composition used in the invention, a photosensitive composition which is usually used for a photosensitive resin layer can be used. Examples thereof include a binder polymer, a photopolymerizable compound, a photopolymerization initiator, blocked isocyanate, and a photosensitive composition including metal oxide particles.

Hereinafter, a preferable material of the photosensitive composition used in the invention will be described. However, the invention is not limited thereto.

### Binder Polymer

Examples of the binder polymer used in the invention include a carboxyl group-containing acrylic resin having an acid value of 60 mgKOH/g or greater.

A binder polymer other than the carboxyl group-containing acrylic resin having an acid value of 60 mgKOH/g or greater may be further included. An arbitrary polymer component can be used without particular limitations as another binder polymer. A component having high surface hardness and high heat resistance is preferable, and an alkali-soluble resin is more preferable. Among alkali-soluble resins, known photosensitive siloxane resin materials and the like can be exemplified.

A binder polymer which is a carboxyl group-containing acrylic resin having an acid value of 60 mgKOH/g or greater is not particularly limited without departing from the spirit of the invention, and can be appropriately selected among known polymers. Binder polymers which are carboxyl group-containing acrylic resins having an acid value of 60 mgKOH/g or greater among polymers described in paragraph 0025 in JP2011-95716A, and binder polymers which are carboxyl group-containing acrylic resins having an acid value of 60 mgKOH/g or greater among polymers described in paragraphs 0033 to 0052 in JP2010-237589A can be used.

The acid value of the binder polymer which is a carboxyl group-containing acrylic resin having an acid value of 60 mgKOH/g or greater is preferably 60 to 200 mgKOH/g, more preferably 70 to 150 mgKOH/g, and particularly preferably 80 to 110 mgKOH/g.

In the invention, regarding the acid value of the binder polymer, a value of a theoretical acid value calculated by a calculation method described in paragraph [0063] in JP2004-149806A, paragraph [0070] in JP2012-211228A, or the like is used.

A polymer latex may be included as the binder polymer used in the invention. Here, the polymer latex is a material in which water-insoluble polymer particles are dispersed in water. Regarding the polymer latex, for example, there is description in “Chemistry of Polymer Latex (published by Kobunshi Kankokai (1973))” written by Soichi Muroi.

As usable polymer particles, particles of an acryl-based, vinyl acetate-based, rubber-based (for example, styrene-butadiene-based or chloroprene-based), olefin-based, polyester-based, polyurethane-based, or polystyrene-based polymer, or a polymer including a copolymer of the above polymers are preferable.

It is preferable to increase the bonding force between polymer chains constituting the polymer particles.

Examples of the means for increasing the bonding force between polymer chains include using an interaction by a hydrogen bond and a method of generating a covalent bond. As means for imparting a hydrogen bonding force, it is preferable to copolymerize or graft-polymerize a monomer having a polar group with the polymer chain and to introduce the resulting material.

Examples of the polar group of the binder polymer include a carboxy group contained in an acrylic acid, a methacrylic acid, an itaconic acid, a fumaric acid, a maleic acid, a crotonic acid, a partially esterified maleic acid, or the like; a primary, secondary, or tertiary amino group; an ammonium base; and a sulfonic group (styrenesulfonic acid).

The copolymerization ratio of the monomer having such a polar group is preferably 5 to 50 mass %, more preferably 5 to 40 mass %, and even more preferably 20 to 30 mass % with respect to 100 mass % of the binder polymer.

In the binder polymer which is a carboxyl group-containing acrylic resin having an acid value of 60 mgKOH/g or greater, the copolymerization ratio of the monomer having a carboxyl group is preferably 5 to 50 mass %, more preferably 5 to 40 mass %, and even more preferably 20 to 30 mass %.

Examples of the means for generating a covalent bond include a method of reacting an epoxy compound, a blocked isocyanate, an isocyanate, a vinyl sulfone compound, an aldehyde compound, a methylol compound, a carboxylic acid anhydride, or the like with a hydroxyl group, a carboxyl group, a primary or secondary amino group, an acetoacetyl group, a sulfonic acid, or the like.

The weight-average molecular weight of the binder polymer is preferably 10,000 or greater, and more preferably 20,000 to 100,000.

The polymer latex which can be used in the invention may be obtained by emulsion polymerization or emulsification.

These polymer latex preparation methods are described in, for example, “Emulsion-Latex Handbook” (edited by Emulsion-Latex Handbook Editorial Committee, published by Taiseisha, Ltd. (1975)).

Examples of the polymer latex which can be used in the invention include an alkyl acrylate copolymer ammonium (trade name: JURYMER AT-210, manufactured by Nihon Junyaku Co., Ltd.), an alkyl acrylate copolymer ammonium (trade name: JURYMER ET-410, manufactured by Nihon Junyaku Co., Ltd.), an alkyl acrylate copolymer ammonium (trade name: JURYMER AT manufactured by Nihon Junyaku Co., Ltd.), and a product obtained by neutralizing a polyacrylic acid (trade name: JURYMER AC-10L, manufactured by Nihon Junyaku Co., Ltd.) with ammonia and emulsifying the resulting material.

### Photopolymerizable Compound

The photopolymerizable compound used in the invention may have at least one ethylenically unsaturated group as a photopolymerizable group, and may have an epoxy group in addition to the ethylenically unsaturated group. As the photopolymerizable compound of the photosensitive transparent resin layer, a compound having a (meth)acryloyl group is more preferably included.

Here, the “(meth)acryloyl group” represents an acryloyl group or a methacryloyl group. Similarly, a “(meth)acrylate” to be described later represents an acrylate or a methacrylate.

The photopolymerizable compound used in the invention may be used singly or in combination of two or more kinds thereof. It is preferable that two or more kinds are used in combination from the viewpoint of improving moisture-heat resistance of the photosensitive resin layer.

Regarding the photopolymerizable compound used in the invention, a tri- or more functional photopolymerizable compound and a bifunctional photopolymerizable compound are preferably used in combination from the viewpoint of improving moisture-heat resistance of the photosensitive resin layer.

The bifunctional photopolymerizable compound is preferably used in the range of 10 to 90 mass %, more preferably used in the range of 20 to 85 mass %, and particularly preferably used in the range of 30 to 80 mass % with respect to all the photopolymerizable compounds.

The tri- or more functional photopolymerizable compound is preferably used in the range of 10 to 90 mass %, more preferably used in the range of 15 to 80 mass %, and particularly preferably used in the range of 20 to 70 mass % with respect to all the photopolymerizable compounds.

As the photopolymerizable compound used in the invention, it is preferable to include at least a compound having two ethylenically unsaturated groups and a compound having at least three ethylenically unsaturated groups, and it is more preferable to include at least a compound having two (meth)acryloyl groups and a compound having at least three (meth)acryloyl groups.

In the invention, it is preferable that at least one kind of photopolymerizable compound having an ethylenically unsaturated group contains a carboxyl group from the viewpoint that the carboxyl group of the binder polymer and the carboxyl group of the photopolymerizable compound having an ethylenically unsaturated group form a carboxylic acid anhydride to further increase the moisture-heat resistance after application of salt water.

The carboxyl group-containing photopolymerizable compound having an ethylenically unsaturated group is not particularly limited, and a commercially available compound can be used. For example, ARONIX TO-2349 (manufactured by Toagosei Co., Ltd.), ARONIX M-520 (manufactured by Toagosei Co., Ltd.), ARONIX M-510 (manufactured by Toagosei Co., Ltd.), or the like can be preferably used.

The carboxyl group-containing photopolymerizable compound having an ethylenically unsaturated group is preferably used in the range of 1 to 50 mass %, more preferably used in the range of 1 to 30 mass %, and particularly preferably used in the range of 5 to 15 mass % with respect to all the photopolymerizable compounds.

It is preferable to include a urethane (meth)acrylate compound as the above-described photopolymerizable compound. The amount of the urethane (meth)acrylate compound to be mixed is preferably 10 mass % or greater, and more preferably 20 mass % or greater with respect to all the photopolymerizable compounds.

Regarding the urethane (meth)acrylate compound, the number of functional groups of the photopolymerizable group, that is, the number of (meth)acryloyl groups is preferably three or greater, and more preferably four or greater.

The photopolymerizable compound having two ethylenically unsaturated groups is not particularly limited as long as it is a compound having two ethylenically unsaturated groups in the molecule, and a commercially available (meth)acrylate compound can be used. For example, tricyclodecane dimethanol diacrylate (A-DCP, manufactured by SHIN-NAKAMURA CHEMICAL CO., LTD.), tricyclodecane dimethanol dimethacrylate (DCP, manufactured by SHIN-NAKAMURA CHEMICAL CO., LTD.), 1,9-nonanediol diacrylate (A-NOD-N, manufactured by SHIN-NAKAMURA CHEMICAL CO., LTD.), 1,6-hexanediol diacrylate (A-HD-N, manufactured by SHIN-NAKAMURA CHEMICAL CO., LTD.), or the like can be preferably used.

The photopolymerizable compound having three or more ethylenically unsaturated groups is not particularly limited as long as it is a compound having three or more ethylenically unsaturated groups in the molecule. For example, (meth)acrylate compounds having a skeleton such as dipentaerythritol (tri/tetra/penta/hexa)acrylate, pentaerythritol (tri/tetra)acrylate, trimethylolpropane triacrylate, ditrimethylolpropane tetraacrylate, or isocyanurate acrylate can be used, and those having a longer span between the (meth)acrylates are preferable. Specific preferable examples thereof include caprolactone-modified compounds (KAYARAD DPCA manufactured by Nippon Kayaku Co., Ltd. and A-9300-1CL manufactured by Shin Nakamura Chemical Co., Ltd.) and alkylene oxide-modified compounds (KAYARAD RP-1040 manufactured by Nippon Kayaku Co., Ltd., ATM-35E and A-9300 manufactured by Shin Nakamura Chemical Co., Ltd., and EBECRYL 135 manufactured by Daicel-Allnex Ltd.) of the (meth)acrylate compounds having a skeleton such as dipentaerythritol (tri/tetra/penta/hexa)acrylate, pentaerythritol (tri/tetra)acrylate, trimethylolpropane triacrylate, ditrimethylolpropane tetraacrylate, or isocyanurate acrylate described above. In addition, a tri-or more functional urethane (meth)acrylate is preferably used. Preferable examples of the tri-or more functional urethane (meth)acrylate include 8UX-015A (manufactured by Taisei Fine Chemical Co., Ltd.), UA-32P (manufactured by Shin Nakamura Chemical Co., Ltd.), and UA-1100H (manufactured by Shin Nakamura Chemical Co., Ltd.).

The photopolymerizable compound used for the transfer film preferably has an average molecular weight of 200 to 3,000, more preferably 250 to 2,600, and particularly preferably 280 to 2,200.

### Photopolymerization Initiator

The photosensitive composition used in the invention includes a photopolymerizable compound and a photopolymerization initiator, and thus the pattern of the photosensitive resin layer can be easily formed.

As the photopolymerization initiator used in the invention, photopolymerization initiators described in paragraphs 0031 to 0042 in JP2011-95716A can be used. For example, 1,2-octanedione,1-[4-(phenylthio)-,2-(O-benzoyloxime)] (trade name: IRGACURE OXE-01, manufactured by BASF SE), ethanone,1-[9-ethyl-6-(2-methylbenzoyl)-9H-carbazole-3-yl]-, 1-(0-acetyloxime) (trade name: IRGACURE OXE-02, manufactured by BASF SE), 2-(dimethylamino)-2-[(4-methylphenyl)methyl]-1-[4-(4-morpholinyl)phenyl]-1-butanone (trade name: IRGACURE 379EG, manufactured by BASF SE), 2-methyl-1-(4-methylthiophenyl)-2-morpholinopropan-1-one (trade name: IRGACURE 907, manufactured by BASF SE), 2-hydroxy-1-{4-[4-(2-hydroxy-2-methyl-propionyl)-benzyl]phenyl}-2-methyl-propane-1-one (trade name: IRGACURE 127, manufactured by BASF SE), 2-benzyl-2-dimethylamino-1-(4-morpholinophenyl)-butanone-1 (trade name: IRGACURE 369, manufactured by BASF SE), 2-hydroxy-2-methyl-1-phenyl-propane-1-one (trade name: IRGACURE 1173, manufactured by BASF SE), 1-hydroxy-cyclohexyl-phenyl-ketone (trade name: IRGACURE 184, manufactured by BASF SE), 2,2-dimethoxy-1,2-diphenylethan-1-one (trade name: IRGACURE 651, manufactured by BASF SE), an oxime ester-based photopolymerization initiator (trade name: Lunar 6, manufactured by DKSH Management Ltd.), or the like can be preferably used.

From the viewpoint of increasing adhesiveness of the plastic substrate to make patterning of the photosensitive resin layer easier, the photopolymerization initiator is preferably included in an amount of 1 mass % or greater, and more preferably 2 mass % or greater with respect to the solid content of the photosensitive composition. In addition, the photopolymerization initiator is preferably included in an amount of 10 mass % or less, and more preferably 5 mass % or less.

### Blocked Isocyanate

The blocked isocyanate used in the invention is a “compound having a structure in which an isocyanate group of an isocyanate is protected (masked) with a blocking agent”.

The dissociation temperature of the blocked isocyanate used in the invention is preferably 100° C. to 160° C., and particularly preferably 130° C. to 150° C.

In the invention, the dissociation temperature of the blocked isocyanate is a “temperature of an endothermic peak associated with a deprotection reaction of a blocked isocyanate in the measurement by differential scanning calorimetry (DSC) analysis by a differential scanning calorimeter (manufactured by Seiko Instruments Inc., DSC6200)”.

Examples of the blocking agent having a dissociation temperature of 100° C. to 160° C. include pyrazole-based compounds (3,5-dimethylpyrazole, 3-methylpyrazole, 4-bromo-3,5-dimethylpyrazole, 4-nitro-3,5-dimethylpyrazole, and the like), active methylene-based compounds (malonic diesters (dimethyl malonate, diethyl malonate, di-n-butyl malonate, di-2-ethylhexyl malonate) and the like), triazole-based compounds (1,2,4-triazole and the like), and oxime-based compounds (formaldoxime, acetaldoxime, acetoxime, methyl ethyl ketoxime, cyclohexanone oxime). Among these, oxime-based or pyrazole-based compounds are preferable, and oxime-based compounds are particularly preferable from the viewpoint of storage stability.

The blocked isocyanate used in the invention preferably has an isocyanurate structure from the viewpoint of brittleness of the photosensitive resin layer and adhesiveness to the plastic substrate.

The number of blocked isocyanate groups of the blocked isocyanate per molecule is preferably 1 to 10, more preferably 2 to 6, and particularly preferably 3 or 4.

Specific examples of the blocked isocyanate used in the invention include the following compounds. However, the blocked isocyanate used in the invention is not limited to the following specific examples.

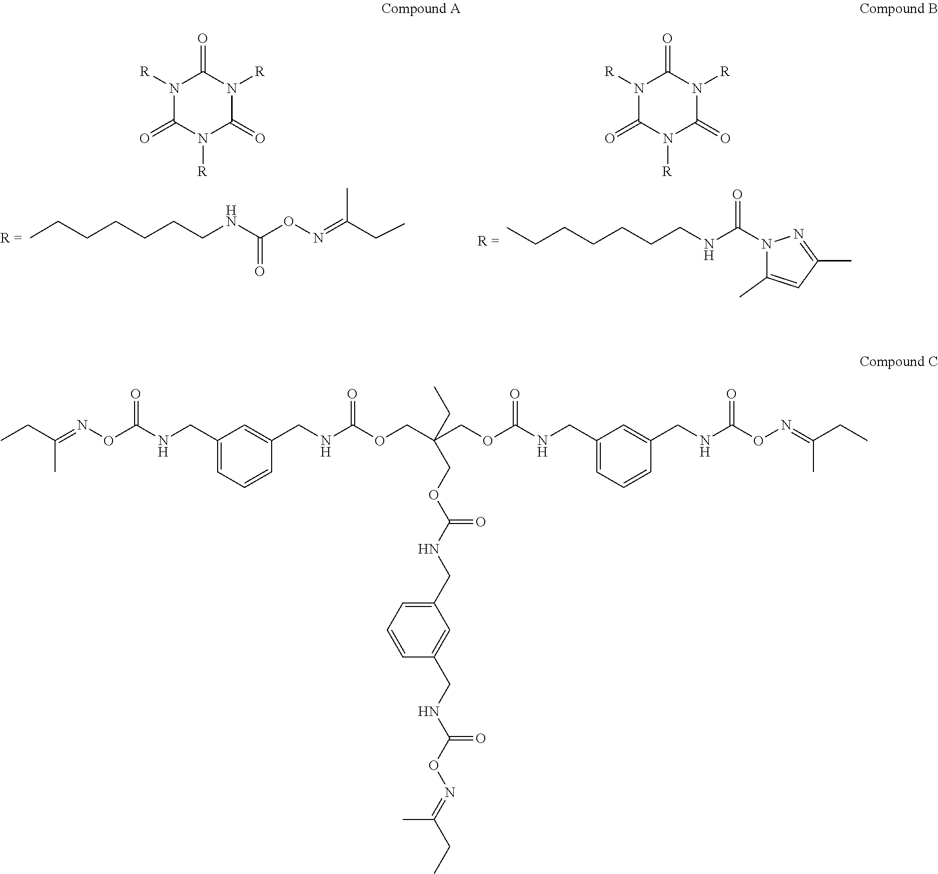

Among the blocked isocyanates having an isocyanurate structure, oxime-based compounds A are preferable from the viewpoint that the dissociation temperature is more easily set within a preferable range than the compounds B having no oxime structure and developability is easily increased.

As the blocked isocyanate used in the invention, commercially available blocked isocyanates can also be exemplified. Examples thereof include TAKENATE (registered trademark) B870N (manufactured by Mitsui Chemicals, Inc.) which is a methyl ethyl ketone oxime-blocked derivative of isophorone diisocyanate and DURANATE (registered trademark) MF-K60B (manufactured by ASAHI KASEI CHEMICALS CORPORATION) which is a hexamethylene diisocyanate-based blocked isocyanate compound.

The molecular weight of the blocked isocyanate used in the invention is preferably 200 to 3,000, more preferably 250 to 2,600, and particularly preferably 280 to 2,200.

### Metal Oxide Particles

The photosensitive resin layer used in the invention may include particles (preferably metal oxide particles) for the purpose of adjusting the refractive index or the light-transmitting property. In order to control the refractive index, metal oxide particles may be included at an arbitrary ratio in accordance with the kind of a polymer or a polymerizable compound to be used.

The metal oxide particles are preferably included in an amount of greater than 0 mass % to 35 mass %, and more preferably in an amount of greater than 0 mass % to 10 mass % with respect to the solid content of the photosensitive composition used in the invention.

In the invention, the metal of the metal oxide particles include semimetals such as B, Si, Ge, As, Sb, and Te.

As metal oxide particles having a light-transmitting property and a high refractive index, oxide particles including atoms of Be, Mg, Ca, Sr, Ba, Sc, Y, La, Ce, Gd, Tb, Dy, Yb, Lu, Ti, Zr, Hf, Nb, Mo, W, Zn, B, Al, Si, Ge, Sn, Pb, Sb, Bi, Te, or the like are preferable. A titanium oxide, a titanium composite oxide, a zinc oxide, a zirconium oxide, an indium/tin oxide, and an antimony/tin oxide are more preferable, a titanium oxide, a titanium composite oxide, and a zirconium oxide are even more preferable, a titanium oxide and a zirconium oxide are particularly preferable, and a titanium dioxide is most preferable. A rutile-type having a high refractive index is particularly preferable as the titanium dioxide. These metal oxide particles can also be surface-treated with an organic material in order to impart dispersion stability.

From the viewpoint of the transparency of the photosensitive resin layer used in the invention, the average primary particle diameter of the metal oxide particles is preferably 1 to 200 nm, and particularly preferably 3 to 80 nm.

Here, the average primary particle diameter of the particles is an arithmetic average of diameters of 200 arbitrary particles measured by an electron microscope. In a case where the particles do not have a spherical shape, the longest side thereof is regarded as a diameter.

The metal oxide particles used in the invention may be used singly or in combination of two or more kinds thereof.

The photosensitive resin layer used in the invention preferably has at least one of ZrO₂ particles, Nb₂O₅ particles, and TiO₂ particles, and more preferably has ZrO₂ particles and Nb₂O₅ particles from the viewpoint of refractive index control.

### Exposure Step and Development Step

In the invention, the method of manufacturing the pattern of the photosensitive resin layer may include an exposure step of exposing the photosensitive resin layer and a development step of developing the exposed photosensitive resin layer.

Hereinafter, a patterning step will be described, including the exposure step and the development step together.

In the patterning step used in the invention, patterning is performed by exposing and developing the photosensitive resin layer formed on the plastic substrate.

In the invention, specific suitable examples of the patterning step include the formation described in paragraphs [0071] to [0077] in JP2006-64921A and the step described in paragraphs [0040] to [0051] in JP2006-23696A.

### Plastic Substrate

The liquid crystal cell according to the invention does not use a conventional glass substrate, but uses a plastic substrate in order to realize three-dimensional formability with a high degree of freedom.

In a case where the liquid crystal cell is three-dimensionally formed, a thermoplastic resin is preferably used as the plastic substrate since local dimensional changes occur such as stretching or contraction. As the thermoplastic resin, a polymer resin is preferable which is excellent in optical transparency, mechanical strength, heat stability, and the like.

Examples of the polymer included in the plastic substrate include polycarbonate-based polymers; polyester-based polymers such as polyethylene terephthalate (PET); acryl-based polymers such as polymethylmethacrylate (PMMA); and styrene-based polymers such as polystyrene and acrylonitrile-styrene copolymers (AS resin).

Examples of the polymer further include polyolefins such as polyethylene and polypropylene; polyolefin-based polymers such as norbornene-based resins and ethylene-propylene copolymers; amide-based polymers such as vinyl chloride-based polymers, nylon, and aromatic polyamides; imide-based polymers; sulfone-based polymers; polyether sulfone-based polymers; polyetheretherketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; cellulose-based polymers represented by triacetylcellulose; and copolymers copolymerized in units of monomers of the above polymers.

Examples of the plastic substrate also include a substrate formed by mixing two or more kinds of the polymers mentioned above as examples.

### Heat-Shrinkable Film

In the production of a three-dimensional structural liquid crystal cell to be described later, in a case where forming is performed using the contraction of the liquid crystal cell, at least one of the at least two plastic substrates is preferably a heat-shrinkable film.

By shrinking the heat-shrinkable film, it is possible to realize three-dimensional formability with a high degree of freedom. Means for shrinkage is not particularly limited, and examples thereof include shrinkage by stretching during the course of film formation. The effect caused by shrinkage of the film itself, shrinkage by residual distortion during film formation, shrinkage by a residual solvent, or the like can also be used.

### Heat Shrinkage Rate

The heat shrinkage rate of the heat-shrinkable film used in the invention is 5% to 75%, preferably 7% to 60%, and more preferably 10% to 45%.

In the heat-shrinkable film used in the invention, the maximum heat shrinkage rate in an in-plane direction of the heat-shrinkable film is preferably 5% to 75%, more preferably 7% to 60%, and even more preferably 10% to 45%. In a case where stretching is performed as means for shrinkage, the in-plane direction in which the maximum heat shrinkage rate is shown coincides with a stretching direction.

In the heat-shrinkable film used in the invention, the heat shrinkage rate in a direction perpendicular to the in-plane direction in which the maximum heat shrinkage rate is shown is preferably 0% to 5%, and more preferably 0% to 3%.

A measurement sample is cut every 5° in the measurement of a heat shrinkage rate under conditions to be described later, heat shrinkage rates in an in-plane direction of all of the measurement samples are measured, and the in-plane direction in which the maximum heat shrinkage rate is shown is specified by a direction in which the maximum measurement value is shown.

In the invention, the heat shrinkage rate is a value measured under the following conditions.

To measure the heat shrinkage rate, a measurement sample having a length of 15 cm and a width of 3 cm with a long side in a measurement direction was cut, and 1 cm-squares were stamped on one film surface in order to measure the film length. A point separated from an upper part of a long side of 15 cm by 3 cm on a central line having a width of 3 cm was set as A, a point separated from a lower part of the long side by 2 cm was set as B, and a distance AB of 10 cm between the points was defined as an initial film length L₀. The film was clipped up to 1 cm away from the upper part of the long side with a clip having a width of 5 cm and hung from the ceiling of an oven heated to a glass transition temperature (Tg) of the film. In this case, the film was put into a tension-free state while not being weighted. The entire film was sufficiently and uniformly heated, and after 5 minutes, the film was taken out of the oven for each clip to measure a length L between the points A and B after the heat shrinkage, and a heat shrinkage rate was obtained through Expression 2.

Heat Shrinkage Rate (%)=100×(L₀−L)/L₀ (Expression 2)

### Glass Transition Temperature (Tg)

The Tg of the heat-shrinkable film used in the invention can be measured using a differential scanning calorimeter.

Specifically, the measurement was performed using a differential scanning calorimeter DSC7000X manufactured by Hitachi High-Tech Science Corporation under conditions of a nitrogen atmosphere and a heating rate of 20° C./min, and a temperature at a point where tangents of respective DSC curves at a peak top temperature of a time differential DSC curve (DDSC curve) of the obtained result and at a temperature of (peak top temperature—20° C.) intersected was set as a Tg.

### Stretching Step

The heat-shrinkable film used in the invention may be an unstretched thermoplastic resin film, but preferably a stretched thermoplastic resin film.

The stretching ratio is not particularly limited, but preferably greater than 0% and not greater than 300%. The stretching ratio is more preferably greater than 0% and not greater than 200%, and even more preferably greater than 0% and not greater than 100% from the practical stretching step.

The stretching may be performed in a film transport direction (longitudinal direction), in a direction perpendicular to the film transport direction (transverse direction), or in both of the directions.

The stretching temperature is preferably around the glass transition temperature Tg of the heat-shrinkable film to be used, more preferably Tg±0° C. to 50° C., even more preferably Tg±0° C. to 40° C., and particularly preferably Tg±0° C. to 30° C.

In the invention, the film may be biaxially stretched simultaneously or sequentially in the stretching step. In a case of sequential biaxial stretching, the stretching temperature may be changed for each stretching in each direction.

In a case of sequential biaxial stretching, it is preferable that first, the film is stretched in a direction parallel to the film transport direction, and then stretched in a direction perpendicular to the film transport direction. The stretching temperature range in which the sequential stretching is performed is more preferably the same as a stretching temperature range in which the simultaneous biaxial stretching is performed.

### Three-dimensional Structural Liquid Crystal Cell

The three-dimensional structural liquid crystal cell according to the invention is formed by changing dimensions of the liquid crystal cell according to the invention by ±5% to 75%.

Here, the dimensional change is a ratio of a difference before and after the change in a case where a dimension before the change is 100. For example, a dimensional change by 30% is a state in which the dimension after change is 130 relative to the dimension (100) before change, and the difference before and after the change is 30.

In addition, the three-dimensional structural liquid crystal cell according to the invention can be produced by three-dimensionally forming the liquid crystal cell according to the invention.

Three-dimensional forming is performed by, for example, rolling the liquid crystal cell according to the invention into a tubular shape, and by then contracting the liquid crystal. For example, by shrinking and forming according to a body shaped like a beverage bottle, a display device or a dimming device can be installed on the bottle, or a display device covering the vicinity of the cylindrical structure can be realized.

Otherwise, under the environment at around the Tg of the plastic substrate, forming can be performed by pressing into a shape corresponding to the mold.

### EXAMPLES

Hereinafter, the invention will be described in detail with reference to examples. The materials, the reagents, the amounts of materials, the proportions thereof, the conditions, the operations, and the like which will be shown in the following examples can be appropriately modified within a range not departing from the gist of the invention. Accordingly, the scope of the invention is not limited to the following examples.

### Example 1

### Production of Plastic Substrate 101

Polycarbonate (manufactured by TEIJIN LIMITED.) having a thickness of 300 μm was heated for 1 minute at 155° C. and stretched in a transverse direction (TD) at a stretching ratio of 100% to obtain a stretched polycarbonate film having a thickness of 150 μm.

The glass transition temperature (Tg) of the stretched polycarbonate film produced as described above was 150° C., and the heat shrinkage rate in the TD measured by the above-described method was 33%.

The in-plane direction in which the maximum heat shrinkage rate was shown substantially coincided with the TD, and the heat shrinkage rate in the machine direction (MD) perpendicular thereto was 3%.

Using the stretched polycarbonate film produced as described above as a plastic substrate, two plastic substrates 101 were prepared in which an indium tin oxide (ITO) transparent electrode having a thickness of 20 nm was formed by vacuum deposition and an alignment film of a vertically aligned polyimide was further formed.

### Preparation of Sealing Material Coating Liquid

A material A-1 which was a coating liquid for a photosensitive resin layer as a sealing material was prepared so as to have a composition as shown in Table 1.

TABLE 1

| | | Material |
|---|---|---|
| | Material | A-1 |
| Binder Polymer | Compound D (acid value: 95 mgKOH/g) | 13.52 |
| Photopolymerizable | Tricyclodecane Dimethanol Diacrylate | 4.87 |
| Compound | (A-DCP, manufactured by SHIN- | |
| | NAKAMURA CHEMICAL CO., LTD.) | |
| | Carboxylic Acid-Containing Monomer | 0.80 |
| | ARONIX TO-2349 (manufactured | |
| | by Toagosei Co., Ltd.) | |
| | Urethane Acrylate 8UX-015A | 2.43 |
| | (manufactured by Taisei Fine | |
| | Chemical Co., Ltd.) | |
| Photopolymerization | Ethanone,1-[9-Ethyl-6-(2- | 0.10 |
| Initiator | Methylbenzoyl)-9H-Carbazole-3-Yl]-1- | |
| | (0-Acetyloxime) (OXE-02, | |
| | manufactured by BASF SE) | |
| | 2-Methyl-1-(4-Methylthiophenyl)-2- | 0.18 |
| | Morpholinopropan-1-one (trade name: | |
| | IRGACURE 907, manufactured by | |
| | BASF SE) | |
| Blocked Isocyanate | Compound A | 3.14 |
| Additive | MEGAFACE F551 (manufactured by | 0.02 |
| | DIC CORPORATION) | |
| Solvent | 1-Methoxy-2-Propyl Acetate | 40.35 |
| | Methyl Ethyl Ketone | 34.59 |

| | |
|---|---|
| Total (part by mass) | 100.00 |

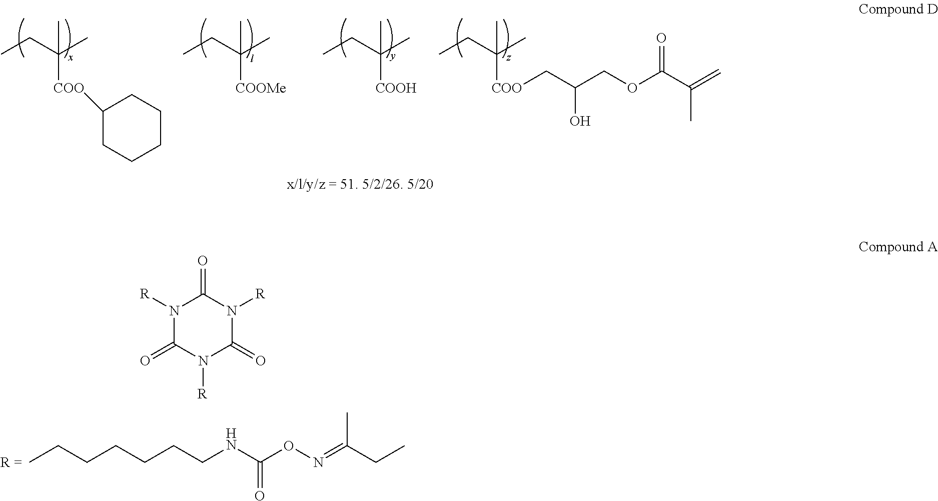

### Production of Transfer Film

The material A-1 for a photosensitive resin layer was coated on a polyethylene terephthalate film having a thickness of 16 μm as a temporary support using a slit-like nozzle while a coating amount thereof was adjusted such that the thickness of a photosensitive resin layer after drying was 8 μm, and the solvent was volatilized in a dry zone at 120° C. to form the photosensitive resin layer.

Finally, a protective film (polyethylene terephthalate film having a thickness of 16 μm) was pressure-bonded, and a transfer film was obtained.

### Production of Sealing Material

The transfer film from which the protective film had been peeled off was laminated on a surface on the transparent electrode and alignment film side of the plastic substrate 101 using FIRST LAMINATOR VAII-700 manufactured by Taisei Laminator Co., LTD. under conditions in which the temperature of the plastic substrate 101 was 40° C., the rubber roller temperature was 110° C., the cylinder pressure was 0.45 MPa, the surface pressure was 0.6 MPa, and the transport speed was 1 m/min.

Then, using a proximity-type exposure machine (manufactured by Hitachi High-Tech Electronics Engineering Co., Ltd.) having a ultrahigh pressure mercury lamp, exposure was performed via the temporary support with an exposure amount of 100 mJ/cm² (i-ray) in a state in which a surface of an exposure mask 1 (quartz exposure mask having a photospacer and a pattern for forming a peripheral frame part) of FIG. 2A and a rear surface of the temporary support are in contact with each other.

After the temporary support was peeled off, a development treatment was performed for 60 seconds by a shower using a 1% aqueous solution of sodium carbonate as a developer, the temperature of which had been adjusted to 32° C. A rinse treatment was performed using pure water after the development treatment, and air blowing was performed to remove moisture.

Next, whole surface exposure was performed with an exposure amount of 375 mJ/cm² (i-ray) from the surface on which the pattern had been formed.

Finally, a heating (post-baking 1) treatment was performed for 30 minutes at 110° C. to form a laminate 101 in which the photosensitive resin layer was patterned on the plastic substrate 101. There was no problem in adhesion to the plastic substrate 101.

A transfer film was separately prepared and the elongation rate of a photosensitive resin layer was measured by the above-described method. The measured rate was 150%.

### Production of Liquid Crystal Cell 101

The laminate 101 produced as described above, in which the photosensitive resin layer was patterned, and another plastic substrate 101 were matched such that the transparent electrode and the alignment film were positioned inside, and the following liquid crystal composition was injected. Then, all of sealing parts (width: 1 cm) of four sides and a photospacer part were sealed to another plastic substrate 101 by curing by a heating (post-baking 2) treatment for 30 minutes at 140° C., and a liquid crystal cell 101 was produced.

### Liquid Crystal Composition

| | |
|---|---|
| Drive Liquid Crystal ZLI2806 manufactured by | 100 parts by mass |
| Merck KGaA | |
| Dichroic Dye G-472 manufactured by Japanese Res. | 3.0 parts by mass |
| Inst. for Photosensitizing Dyes Co., Ltd. | |
| Chiral Agent Cholesterol Pelargonate manufactured | 1.74 parts by mass |
| by Tokyo Chemical Industry Co., Ltd. | |

### Production of Three-Dimensional Structural Liquid Crystal Cell 101

The liquid crystal cell 101 produced as described above was rolled from its long side which was 30 cm long to have a cylindrical tubular shape. Then, an overlapping part of the sides which were 10 cm long was provided as a 1 cm-part in which the cell was sealed, and a pressure of 1 MPa was applied thereto for 1 minute at 200° C. for thermal pressure bonding and fixing to produce a three-dimensional structural liquid crystal cell precursor 101 having a tubular shape. The peripheral length was 29 cm.

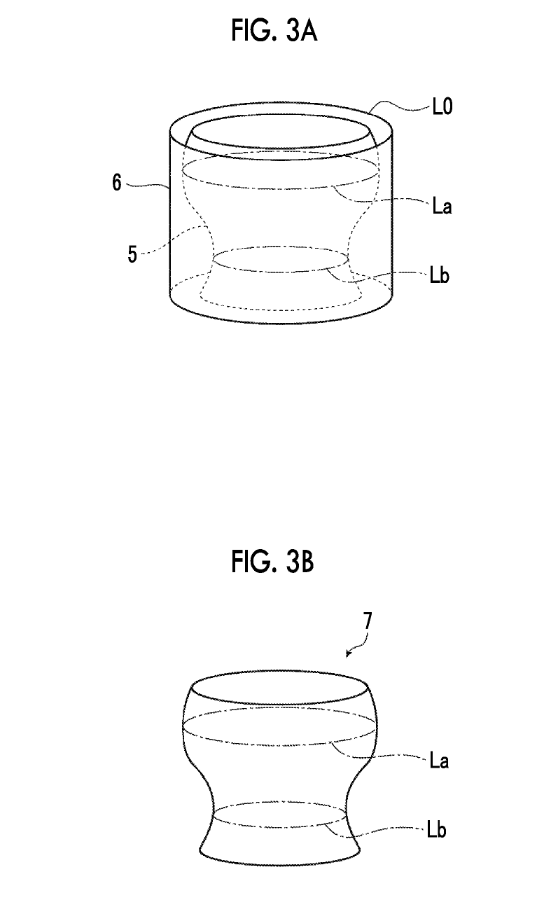

A mold 1 having a shape shown in FIG. 3A was prepared. The maximum peripheral length La was 25 cm, and the minimum peripheral length Lb was 20 cm. The three-dimensional structural liquid crystal cell precursor 101 (reference 6) having a tubular shape with a peripheral length L0 of 29 cm, which had been produced as described above, was disposed at a position shown in FIG. 3A with respect to the mold, and heated and formed for 5 minutes at a temperature of 150° C. to produce a three-dimensional structural liquid crystal cell 101 (reference 7) shown in FIG. 3B. It was possible to perform the forming such that the three-dimensional structural liquid crystal cell precursor followed any of the part having the peripheral length La and the part having the peripheral length Lb. The peripheral lengths of the respective parts were 25 cm and 20 cm, respectively, in accordance with the shape of the mold. In addition, there was no problem in sealability of the liquid crystal cell.

Another liquid crystal cell 101 was prepared by the above-described producing method and stretched by 20%. In this case, there was also no problem in sealability of the liquid crystal cell.

### Example 2

Regarding an exposure mask, a substrate was produced in the same manner as in Example 1, except for changes shown in FIG. 2B, and then a constant cell gap of 8 μm was kept using a spherical spacer (MICROPEARL SP208 manufactured by SEKISUI FINE CHEMICAL CO., LTD.) to inject a liquid crystal composition in the same manner as in Example 1. After that, all the four sides were sealed by curing with a width of 1 cm with an ultraviolet (UV) adhesive to produce a liquid crystal cell 102.

A three-dimensional structural liquid crystal cell 102 was produced in the same manner as in Example 1. There was no problem in sealability of the liquid crystal cell.

Another liquid crystal cell 102 was prepared by the above-described producing method and stretched by 20%. In this case, there was also no problem in sealability of the liquid crystal cell.

### Comparative Example 1

A liquid crystal cell 103 was produced in the same manner in Example 2, except that as the sealing material, a sealing material described in Example 1 in JP1988-18523A (JP-S63-18523A) was reproduced in place of the photosensitive resin layer and patterning printing was performed. The elongation rate of the sealing material was 3%.

A three-dimensional structural liquid crystal cell 103 was produced in the same manner as in Example 2. The sealing material was peeled off and the liquid crystal composition in the liquid crystal cell flowed out.

Another liquid crystal cell 103 was prepared by the above-described producing method and stretched by 20%. In this case, too, the sealing material was peeled off and the liquid crystal composition in the liquid crystal cell flowed out.

### EXPLANATION OF REFERENCES

1: photosensitive resin layer

2: plastic substrate

3: light transmission part

4: light shielding part

5: mold

6: three-dimensional structural liquid crystal cell precursor

7: three-dimensional structural liquid crystal cell

L0: peripheral length before contraction

La: maximum peripheral length

Lb: minimum peripheral length

What is claimed is:

1. A liquid crystal cell comprising:
at least two plastic substrates;
a liquid crystal layer; and
a sealing material which has an elongation rate of 5% to 200% between two neighboring ones of the plastic substrates,
wherein the liquid crystal layer is sealed with the sealing material.

2. The liquid crystal cell according to claim 1,
wherein the sealing material is a photosensitive resin layer.

3. The liquid crystal cell according to claim 1,
wherein at least one of the plastic substrates is a heat-shrinkable film satisfying a heat shrinkage rate of 5% to 75%.

4. The liquid crystal cell according to claim 2,
wherein at least one of the plastic substrates is a heat-shrinkable film satisfying a heat shrinkage rate of 5% to 75%.

5. The liquid crystal cell according to claim 3,
wherein all the plastic substrates are heat-shrinkable films satisfying a heat shrinkage rate of 5% to 75%.

6. The liquid crystal cell according to claim 4,
wherein all the plastic substrates are heat-shrinkable films satisfying a heat shrinkage rate of 5% to 75%.

7. The liquid crystal cell according to claim 1,
wherein at least one of the plastic substrates is a thermoplastic resin film stretched at a ratio of greater than 0% and not greater than 300%.

8. The liquid crystal cell according to claim 2,
wherein at least one of the plastic substrates is a thermoplastic resin film stretched at a ratio of greater than 0% and not greater than 300%.

9. The liquid crystal cell according to claim 3,
wherein at least one of the plastic substrates is a thermoplastic resin film stretched at a ratio of greater than 0% and not greater than 300%.

10. The liquid crystal cell according to claim 4,
wherein at least one of the plastic substrates is a thermoplastic resin film stretched at a ratio of greater than 0% and not greater than 300%.

11. The liquid crystal cell according to claim 5,
wherein at least one of the plastic substrates is a thermoplastic resin film stretched at a ratio of greater than 0% and not greater than 300%.

12. The liquid crystal cell according to claim 6,
wherein at least one of the plastic substrates is a thermoplastic resin film stretched at a ratio of greater than 0% and not greater than 300%.

13. A three-dimensional structural liquid crystal cell which is formed by changing dimensions of the liquid crystal cell according to claim 1 by ±5% to 75%.

14. A three-dimensional structural liquid crystal cell which is formed by changing dimensions of the liquid crystal cell according to claim 2 by ±5% to 75%.

15. A three-dimensional structural liquid crystal cell which is formed by changing dimensions of the liquid crystal cell according to claim 3 by ±5% to 75%.

16. A three-dimensional structural liquid crystal cell which is formed by changing dimensions of the liquid crystal cell according to claim 4 by ±5% to 75%.

17. A three-dimensional structural liquid crystal cell which is formed by changing dimensions of the liquid crystal cell according to claim 5 by ±5% to 75%.

18. A three-dimensional structural liquid crystal cell which is formed by changing dimensions of the liquid crystal cell according to claim 6 by ±5% to 75%.

19. A three-dimensional structural liquid crystal cell which is formed by changing dimensions of the liquid crystal cell according to claim 7 by ±5% to 75%.

20. A three-dimensional structural liquid crystal cell which is formed by changing dimensions of the liquid crystal cell according to claim 8 by ±5% to 75%.
